(19) United States
(12) Patent Application Publication
(10) Pub. No.: US 2018/0297596 A1
(43) Pub. Date: Oct. 18, 2018

(54) Path Planning Method, Apparatus, And System

(71) Applicant: HUAWEI TECHNOLOGIES CO., LTD., Shenzhen (CN)

(72) Inventors: Li LI, Beijing (CN); Jingwei LI, Beijing (CN)

(21) Appl. No.: 16/012,091

(22) Filed: Jun. 19, 2018

Related U.S. Application Data
(63) Continuation of application No. PCT/CN2017/103892, filed on Sep. 28, 2017.

(30) Foreign Application Priority Data
Dec. 28, 2016 (CN) 201611232806.9

(51) Int. Cl. B60W 30/16; B60W 30/12; B60W 30/18

(52) U.S. Cl. CPC B60W 30/162; B60W 30/12; B60W 30/18154; B60W 2550/40; B60W 2550/302; B60W 2550/304; B60W 30/18163

(57) ABSTRACT

Implementations of path planning methods, devices, and systems are disclosed. In an implementation, a first velocity set of a target vehicle is determined according to a first velocity set of a reference vehicle of the target vehicle. The first velocity set includes velocity information in one-to-one correspondence to at least one time point. The first segment is a next segment of a current driving segment of the target vehicle, and the reference vehicle is a preceding vehicle of the target vehicle; and sending the first velocity set of the target vehicle to the target vehicle. Lane-level path planning can be implemented for a road lane, a ramp, and a crossroad etc. By planning a driving velocity of a vehicle in advance, overall traffic efficiency can be improved and a possibility of traffic accidents can be reduced.

### CROSS-REFERENCE TO RELATED APPLICATIONS

This application is a continuation of International Application No. PCT/CN2017/103892, filed on Sep. 28, 2017, which claims priority to Chinese Patent Application No. 201611232806.9, filed on Dec. 28, 2016, The disclosures of the aforementioned applications are hereby incorporated by reference in their entireties.

### STATEMENT OF JOINT RESEARCH AGREEMENT

The subject matter and the claimed invention were made by or on the behalf of Tsinghua University, of Haidian District, Chengdu, P.R. China and Huawei Technologies Co., Ltd., of Shenzhen, Guangdong Province, P.R. China, under a joint research agreement titled “Path Planning Method, Apparatus, and System”. The joint research agreement was in effect on or before the claimed invention was made, and that the claimed invention was made as a result of activities undertaken within the scope of the joint research agreement.

### TECHNICAL FIELD

Embodiments of this application relate to the navigation field, and in particular, to a path planning method, apparatus, and system.

### BACKGROUND

Cars have become an indispensable transportation means for people today, and path planning has gradually come into people's life as people expect more control over time.

Current path planning is to provide path guidance instruction information, such as an optimum driving route and information of intersection turning, to a driver. When driving a car according to the path guidance instruction information, the driver needs to determine a correspondence between the path guidance instruction and a lane to drive in according to an actual traffic sign and marking, and then selects a proper lane and a proper velocity for driving. That is, a path guidance function in the prior art is not thorough path guidance, and there is discrepancy between a guidance instruction of the path guidance function and an actual travel requirement. This discrepancy tends to divert attention of the driver, which induces a great possibility of traffic accidents.

### SUMMARY

In view of this, embodiments of this application provide a path planning method, apparatus, and system, so as to implement lane-level path planning, and by planning a driving velocity of a vehicle in advance, overall traffic efficiency can be improved and a possibility of traffic accidents can be reduced. In addition, pressure of an excessive computation amount on a control center can be reduced through segment-based planning.

According to a first aspect, a path planning method is provided, where the method may include: determining a first velocity set of a target vehicle according to a first velocity set of a reference vehicle of the target vehicle, where the first velocity set of the target vehicle is used to guide the target vehicle to drive in a first segment, and the first velocity set includes velocity information in one-to-one correspondence to at least one time point, the first segment is a next segment of a current driving segment of the target vehicle, the segment is a fixed length of road in a lane, and the reference vehicle is a preceding vehicle of the target vehicle; and sending the first velocity set of the target vehicle to the target vehicle.

The velocity set is a set formed by a plurality of pieces of velocity information, and the plurality of pieces of velocity information are associated with time points, or may be associated with displacements.

Optionally, a control center may monitor all vehicles in an entire road section, and velocities of all vehicles in each segment may rely on the technical solution in this application. Specifically, the control center may plan a velocity of a vehicle in each segment according to a vehicle safety distance.

By planning a velocity of the target vehicle in the next segment of the current driving segment in advance, overall traffic efficiency can be improved, and a possibility of traffic accidents can be reduced.

In a possible implementation, when the target vehicle drives in a lane of a straight-going road section, a preceding vehicle nearest to the target vehicle may be determined as the reference vehicle. In planning, preceding vehicles of the target vehicle in all lanes may be considered, for example, a vehicle that drives ahead of the target vehicle in a lane in which the target vehicle is currently located may be considered, and a vehicle that is ahead of the target vehicle in another lane may also be considered, so that a collision rate can be further reduced.

In addition, a vehicle that drives in another lane ahead of the target vehicle at the time of planning but afterwards drives into the first segment earlier than the target vehicle because of acceleration may also be considered, or a vehicle that drives in another lane behind the target vehicle at the time of planning but afterwards drives into the first segment later than the target vehicle because of deceleration may be considered.

A road section is a largest traffic model in a traffic scenario, and each road in the road section is referred to as a lane.

In a possible implementation, the planned first segment belongs to a lane of a ramp model, and a preceding vehicle nearest to the target vehicle may be determined as the reference vehicle.

Similarly, in planning, preceding vehicles of the target vehicle in all lanes of a road section intersecting a ramp and preceding vehicles of the target vehicle in all lanes of the ramp may be considered, for example, a vehicle that drives ahead of the target vehicle in a lane in which the target vehicle is currently located may be considered, and a vehicle that is ahead of the target vehicle in another lane may also be considered, so that a collision rate can be further reduced.

The ramp model includes a driving-in segment, a driving-out segment, a ramp segment, and a center area. The driving-in segment and driving-out segment each are a segment in a lane of a road section intersecting the ramp.

In addition, a vehicle that drives in another lane of the ramp or the road section ahead of the target vehicle at the time of planning but afterwards drives into the first segment earlier than the target vehicle because of acceleration may also be considered, or a vehicle that drives in another lane of the ramp or the road section behind the target vehicle at the time of planning but afterwards drives into the first segment later than the target vehicle because of deceleration may be considered.

In a possible implementation, the first segment is a first lane in a traffic crossroad, the traffic crossroad further includes a second lane, the first lane and the second lane have an intersection point, and the method further includes: determining a preceding vehicle nearest to the intersection point as the reference vehicle, where the preceding vehicle includes at least one vehicle a distance from which to the intersection point is less than a distance from the target vehicle to the intersection point.

A lane in a traffic crossroad or in an intersection area of a ramp model is a fixed driving track. That is, a vehicle cannot perform lane change in a lane of the intersection area or the traffic crossroad, meaning less freedom than in a lane of a straight-going road section.

In a possible implementation, the method further includes: determining a second velocity set of the target vehicle according to the first velocity set of the reference vehicle and a traffic status of a second segment, where the second velocity set includes velocity information in one-to-one correspondence to at least one time point, the second velocity set is used to provide reference for planning a velocity at which the target vehicle drives in the second segment when the target vehicle drives in the first segment, and the second segment is a next segment into which the target vehicle drives from the first segment; and sending the second velocity set to the target vehicle.

This rolling planning approach can avoid a collision at a place at which a plurality of road sections connect.

In a possible implementation, the current driving segment and the first segment belong to different lanes of the road section, and after the determining a first velocity set of a target vehicle according to a first velocity set of a reference vehicle of the target vehicle, the method further includes: determining, according to the first velocity set of the target vehicle and a normal distance of a radial center line of the first segment, an angular velocity required for the target vehicle to drive from the current driving segment into the first segment; and sending the angular velocity to the target vehicle.

According to a second aspect, a path planning method is provided, where the method includes: receiving a first velocity set of a target vehicle sent by a control center, where the first velocity set of the target vehicle is determined according to a first velocity set of a reference vehicle of the target vehicle; and controlling the target vehicle to drive in a first segment according to the first velocity set of the target vehicle; where the first velocity set includes velocity information in one-to-one correspondence to at least one time point, the first segment is a next segment of a current driving segment of the target vehicle, the segment is a fixed length of road in a lane, and the reference vehicle is a preceding vehicle of the target vehicle.

In a possible implementation, the method further includes: receiving a second velocity set of the target vehicle sent by the control center, where the second velocity set includes velocity information in one-to-one correspondence to at least one time point, the second velocity set is used to provide reference for planning a velocity at which the target vehicle drives in a second segment when the target vehicle drives in the first segment, and the second segment is a next segment into which the target vehicle drives from the first segment.

In a possible implementation, the current driving segment and the first segment each are a fixed length of road in a different lane of a road section, the road section includes a plurality of parallel lanes, and the method further includes: receiving an angular velocity that is sent by the control center and that is required for the target vehicle to drive from the current driving segment into the first segment.

According to a third aspect, an apparatus is provided, configured to implement the method in any one of the first aspect or the possible implementations of the first aspect. Specifically, the apparatus includes a unit configured to implement the method in any one of the first aspect or the possible implementations of the first aspect.

According to a fourth aspect, an apparatus is provided, configured to implement the method in any one of the second aspect or the possible implementations of the second aspect. Specifically, the apparatus includes a unit configured to implement the method in any one of the second aspect or the possible implementations of the second aspect.

According to a fifth aspect, a system is provided, where the system includes the apparatus in any one of the third aspect or the possible implementations of the third aspect and the apparatus in any one of the fourth aspect or the possible implementations of the fourth aspect.

According to a sixth aspect, an apparatus is provided, where the apparatus includes a memory, a processor, and a transceiver. The memory, the processor, and the transceiver communicate with each other by using an internal connection path to transfer a control and/or data signal. The memory is configured to store an instruction, the processor is configured to execute the instruction stored in the memory, and when the instruction is executed, the processor controls the transceiver to receive input data and information, and to output data such as an operation result.

According to a seventh aspect, an apparatus is provided, and the apparatus includes a memory, a processor, and a bus system. The memory, the processor, and the transceiver communicate with each other by using an internal connection path to transfer a control and/or data signal. The memory is configured to store an instruction, the processor is configured to execute the instruction stored in the memory, and when the instruction is executed, the processor controls the transceiver to receive input data and information, and to output data such as an operation result.

According to an eighth aspect, a computer storage medium is provided, configured to store a computer software instruction used for the foregoing method, where the computer software instruction includes a program designed for implementing the first aspect.

According to a ninth aspect, a computer storage medium is provided, configured to store a computer software instruction used for the foregoing method, where the computer software instruction includes a program designed for implementing the second aspect.

These or other aspects of the embodiments of this application are more concise and easier to understand in later descriptions of the embodiments.

### BRIEF DESCRIPTION OF DRAWINGS

FIG. 1 is a schematic diagram of a traffic model of a partial straight-going road section;

FIG. 2 is a schematic diagram of a ramp model;

FIG. 3 is a schematic diagram of a traffic crossroad model;

FIG. 4 is a schematic block diagram of a path planning method according to an embodiment of this application;

FIG. 5 is a flowchart of a path planning method according to an embodiment of this application;

FIG. 6 is a schematic diagram of simulation of straight-going path planning;

FIG. 7 is another schematic block diagram of a path planning method according to an embodiment of this application;

FIG. 8 is a schematic block diagram of a path planning apparatus according to an embodiment of this application;

FIG. 9 is another schematic block diagram of a path planning apparatus according to an embodiment of this application;

FIG. 10 is a schematic block diagram of a system according to an embodiment of this application;

FIG. 11 is still another schematic block diagram of a path planning apparatus according to an embodiment of this application; and

FIG. 12 is yet another schematic block diagram of a path planning apparatus according to an embodiment of this application.

### DESCRIPTION OF EMBODIMENTS

The following describes technical solutions in the embodiments of this application with reference to the accompanying drawings.

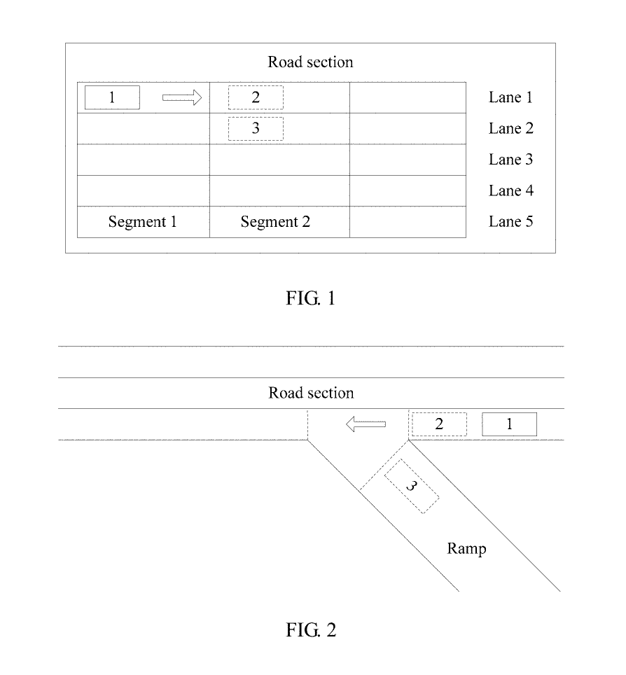

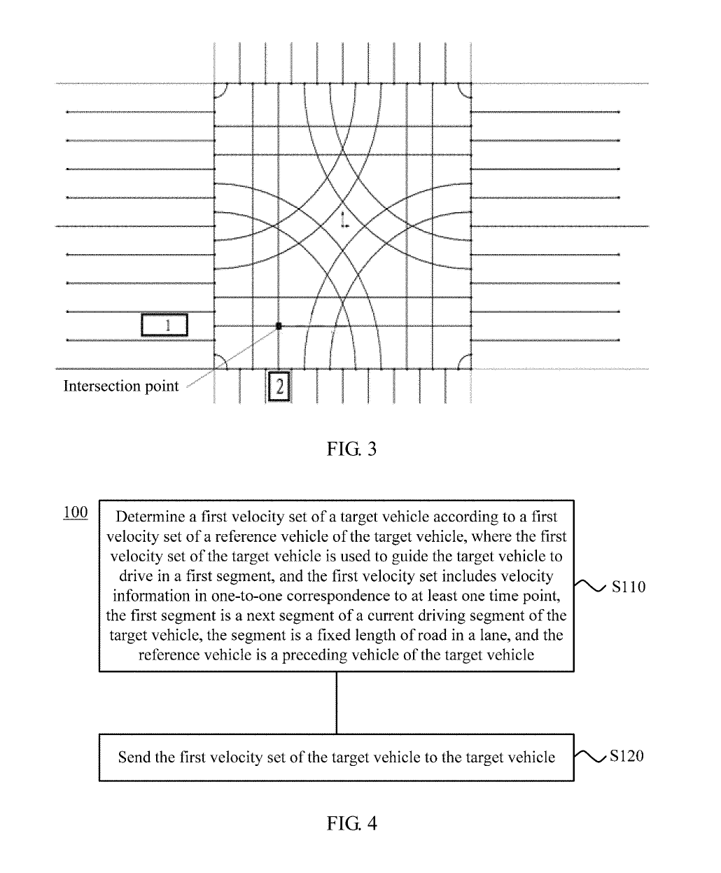

FIG. 1 to FIG. 3 are schematic diagrams of three main traffic models to which the embodiments of this application relate. Specifically, FIG. 1 is a schematic diagram of a traffic model of a partial straight-going road section. Herein, the road section is a largest traffic model in a traffic scenario. Each road in a road section is referred to as a lane, a vehicle is randomly generated from a start end of each lane, and a number of a driving-out lane of a driving-out road section is also randomly generated. For a lane, a basic unit for planning a vehicle velocity is referred to as a segment. The segment is a fixed length of road in a lane, and when a vehicle enters the segment from the start end, a planning algorithm is executed for the vehicle. For example, when the vehicle drives in a segment 1 at a planning time point, a control center may determine, according to a technical solution in this embodiment of this application, a velocity at which the vehicle drives in a segment 2. FIG. 2 is a schematic diagram of a ramp model. A ramp model is divided into an on-road ramp model and an off-road ramp model. The on-road ramp model and the off-road ramp model are the same except for different driving directions of vehicles. An on-road ramp in FIG. 2 is used as an example. The ramp model includes a driving-in segment, a driving-out segment, a ramp segment, and an intersection area. The driving-in segment and driving-out segment each are a segment in a lane of a road section intersecting the ramp. FIG. 3 is a schematic diagram of a traffic crossroad model. For example, at a crossroad, each lane is corresponding to a straight line or a curve included in the crossroad (left-turning and right-turning are denoted by curves, and straight-going is denoted by a straight line). In this way, twenty trails at the crossroad that are for vehicles are formed (it may be stipulated that no lane change be performed at the crossroad).

FIG. 1 to FIG. 3 describe the three traffic models applied in the embodiments of this application, but the embodiments of this application are not limited thereto. The embodiments of this application may be not only applicable to vehicle planning, but also of instructive meaning for flight planning and sea voyage planning.

A path planning technology is a technology of driving route guidance for a vehicle on a road, and is a modern technology based on electronics, computers, networks, and communication, so as to provide a path guidance instruction to a driver. A relatively mature path planning technology is mainly road-level path planning. For example, the commonly used Baidu Map and Gaode Map can obtain road-level planning of a shortest route and a shortest time through computation according to a start point and a destination. There is also much research on lane-level path planning, in which a solution is usually found by using an analytic function. A two-dimensional coordinate system is established according to a traverse direction and a longitudinal direction of a road, and a to-be-solved vehicle track is specified to be a higher-degree polynomial. For a vehicle performing lane change, generally, a polynomial of degree 5 or 6 with undetermined coefficients is set as a to-be-solved path, and then a known planned path and the to-be-solved path are used to form an equation set to be simultaneously solved, so as to find the coefficients of all terms. However, the technical solution in this embodiment of this application is implemented based on a simulation solution.

FIG. 4 is a schematic block diagram of a path planning method 100 according to an embodiment of this application. As shown in FIG. 2, the method 100 may be implemented by a control center, and the method 100 includes the following steps:

S110. Determine a first velocity set of a target vehicle according to a first velocity set of a reference vehicle of the target vehicle, where the first velocity set of the target vehicle is used to guide the target vehicle to drive in a first segment, and the first velocity set includes velocity information in one-to-one correspondence to at least one time point, the first segment is a next segment of a current driving segment of the target vehicle, the segment is a fixed length of road in a lane, and the reference vehicle is a preceding vehicle of the target vehicle.

S120. Send the first velocity set of the target vehicle to the target vehicle.

Specifically, a control center determines, by using a car-following algorithm, the first velocity set according to which the target vehicle may drive in the next segment of the current driving segment, and the target vehicle may drive in the next segment according to the first velocity set of the target vehicle when receiving the velocity set of the target vehicle. By planning the velocity set of the vehicle in advance, a driver in the target vehicle does not need to determine a driving velocity of the vehicle subjectively according to a traffic status, so that a vehicle collision caused by a subjective factor of the driver can be avoided.

The technical solution of this application is based on planning of a segment. This segment is determined according to a processing capability of the control center. A length of the segment may be 1000 m, 2000 m, or the like. In this embodiment of this application, the length of the segment is not specifically limited.

It should be understood that, the velocity set is a set formed by a plurality of pieces of velocity information, and the plurality of pieces of velocity information are associated with time points, or may be associated with displacements. For example, the velocity set may include a velocity 1 (5 m/s) corresponding to 0 s, a velocity 2 (6 m/s) corresponding to 5 s, and the like. For another example, the length of the segment is 100 m, and the velocity set includes a velocity 5 m/s corresponding to 0 m to 20 m, a velocity 6 m/s corresponding to 20 m to 40 m, and the like. What are specifically associated with the plurality of pieces of velocity information in the velocity set are not limited in this embodiment of this application.

It should also be understood that the first velocity set of the reference vehicle may be a set of all velocities of the reference vehicle in an entire road section, or may a set of some velocities of the reference vehicle that are associated with the to-be-planned first segment, and the first velocity set of the reference vehicle may be obtained according to the technical solution given in this embodiment of this application.

It should also be understood that the preceding vehicle includes vehicles in each lane of the entire road section that drive into a second segment earlier than the target vehicle. For example, in a straight-going road section shown in FIG. 1, it is assumed that a target vehicle is a vehicle 1. Then, for planning of a first velocity set of the vehicle 1 in a segment 2 of a lane 2, all vehicles in each lane from a lane 1 to a lane 5 in the entire road section that drive into the segment 2 of the lane 2 earlier than the vehicle 1 may be considered. Specifically, a vehicle that is ahead of the vehicle 1 at a planning time point and drives into the segment 2 of the lane 2 earlier than the vehicle 1 may be included, a vehicle that is behind the vehicle 1 at the planning time moment but drives into the segment 2 of the lane 2 earlier than the vehicle 1 may be included, and a vehicle that is ahead of the vehicle 1 at the planning time point but drives into the segment of the lane 2 later than the vehicle 1 may also be considered. In short, the preceding vehicle is not limited in this embodiment of this application.

Optionally, the control center may monitor all vehicles in an entire road section, and velocities of all vehicles in each segment may rely on the technical solution in this application. Specifically, the control center may further plan a velocity of a vehicle in each segment according to a vehicle safety distance. In addition, the preceding vehicle may alternatively be determined according to velocity information and acceleration information of all vehicles in the entire road section monitored by the control center.

Optionally, a preceding vehicle nearest to the target vehicle may be regarded as the reference vehicle, or a preceding vehicle second nearest to the target vehicle may be regarded as the reference vehicle. This is not limited in this embodiment of this application.

Further, the first segment may be a segment in a lane, may be an intersection area of a road section and a ramp, or may be a traffic crossroad area. The following describes first segments in the three models in detail one by one.

Optionally, the first segment is a fixed length of road in any lane of a first road section, the first road section includes a plurality of parallel lanes, and the method further includes: determining a preceding vehicle nearest to the target vehicle as the reference vehicle, where the preceding vehicle includes at least one vehicle in each lane of the first road section that drives into the first segment earlier than the target vehicle.

Specifically, in a planning process, all preceding vehicles of the target vehicle may be considered. For example, a vehicle 1 in FIG. 1 is regarded as a target vehicle, and a reference vehicle of the vehicle 1 may be a preceding vehicle in a driving direction of the vehicle 1 in a lane 1, for example, a vehicle nearest to the vehicle 1 in the driving direction of the vehicle 1 in the lane 1. Alternatively, a reference vehicle of the vehicle 1 may be a vehicle, in a lane 2 or a lane 3, or even a lane 4 or a lane 5, whose projection onto the lane 1 precedes the vehicle 1, for example, a vehicle in the lane 2 whose projection onto the lane 1 is nearest to the vehicle 1. When a next segment into which the vehicle 1 drives still belongs to the lane 1, a preceding vehicle of the vehicle 1 in the lane 1, and vehicles in the lane 2 to the lane 5 whose projections onto the lane 1 precede the vehicle 1 need to be considered, and a vehicle that is nearest to the vehicle 1 among all preceding vehicles is the reference vehicle.

Optionally, the first segment is any lane in an intersection area of a third road section and a ramp, the third road section includes a plurality of parallel lanes, the ramp includes a plurality of parallel lanes, and the method further includes: determining a preceding vehicle nearest to the target vehicle as the reference vehicle, where the preceding vehicle includes at least one vehicle in each lane of the third road section and the ramp that drives into the first segment earlier than the target vehicle.

For example, a vehicle 1 in FIG. 2 is regarded as a target vehicle. A reference vehicle of the vehicle 1 may be a preceding vehicle nearest to the vehicle 1 in a lane in which the vehicle 1 is located, or may be a preceding vehicle in a ramp whose projection onto a lane in which the vehicle 1 is located is nearest to the vehicle 1. If the vehicle 1 drives into an intersection area from the ramp, the reference vehicle of the vehicle 1 may be a preceding vehicle nearest to the vehicle 1 in the ramp, or may be a preceding vehicle in the lane whose projection onto the ramp is nearest to the vehicle 1.

Optionally, the first segment is a first lane in a traffic crossroad, the traffic crossroad further includes a second lane, the first lane and the second lane have an intersection point, and the method further includes: determining a preceding vehicle nearest to the intersection point as the reference vehicle, where the preceding vehicle includes at least one vehicle a distance from which to the intersection point is less than a distance from the target vehicle to the intersection point.

A lane in a traffic crossroad or in an intersection area of a ramp model is a fixed driving track. That is, a vehicle cannot perform lane change in a lane of the intersection area or the traffic crossroad, meaning less freedom than in a lane of a straight-going road section.

For example, a vehicle 1 in FIG. 3 is regarded as a target vehicle. A reference vehicle of the vehicle 1 may be a vehicle 2. Specifically, by determining a magnitude relationship between a distance from the vehicle 1 to an intersection point in FIG. 3 and a distance from the vehicle 2 to the intersection point in FIG. 3, if the distance from the vehicle 1 to the intersection point is greater than the distance from the vehicle 2 to the intersection point, the vehicle 2 may be regarded as the reference vehicle of the vehicle 1; or if the distance from the vehicle 1 to the intersection point is less than the distance from the vehicle 2 to the intersection point, the vehicle 1 may be regarded as a reference vehicle of the vehicle 2.

It should be understood that there may be one or more preceding vehicles for vehicles 1 in FIG. 1 to FIG. 3. The reference vehicle may be a preceding vehicle nearest to the target vehicle, or may be a preceding vehicle second nearest to the target vehicle. This is not limited in this embodiment of this application.

It should be understood that the foregoing is merely schematic examples of a determining manner of the reference vehicle of the target vehicle. This embodiment of this application is not limited thereto. For example, for on-road driving, a priority for a vehicle to enter an intersection area may further be considered. A vehicle of a higher priority drives into the intersection area earlier than a vehicle of a lower priority.

For example, the intersection area in FIG. 2 may be an area in which the entire road section intersects the ramp, or may be an area in which a lane intersects the ramp. Specifically, if the intersection area is an area in which the entire road section intersects the ramp, the intersection area may be dived into two parts. FIG. 2 is used as an example. It may be specified that a vehicle can only go straight in two lanes not intersecting the ramp, and a vehicle can drive off a lane intersecting the ramp. By limiting a driving track of a vehicle in this way, although an area use rate is reduced to some degree, a velocity set of the vehicle can still be adjusted by applying a car-following idea, to ensure that a rear-end collision is avoided for the vehicle in the intersection area.

It should be understood that it is more complex to determine a reference vehicle for on-road driving than to determine a reference vehicle for off-road driving. Specifically, for on-road planning, a visual field between a vehicle in an arterial road and a vehicle in a ramp needs to be further considered, that is, a necessary car-following relationship that may exist between the two vehicles need to be considered. In other words, during off-road planning, a visual field between a vehicle in an arterial road and a vehicle in a ramp may not be considered.

Optionally, in this embodiment of this application, the current driving segment and the first segment belong to different lanes of the road section, and after the determining a first velocity set of a target vehicle according to a first velocity set of a reference vehicle of the target vehicle, the method further includes: determining, according to the first velocity set of the target vehicle and a normal distance of a radial center line of the first segment, an angular velocity required for the target vehicle to drive from the current driving segment into the first segment; and sending the angular velocity to the target vehicle.

Specifically, if the target vehicle has a lane change requirement in this segment, an angular velocity for performing lane change may be planned after the target vehicle passes a natural lane change point. Obtaining of the angular velocity herein relies on a velocity of a vehicle head and a normal distance from the vehicle to a radial center line of a to-drive-into lane of this segment. A section of road in the segment in which the target vehicle is located may be stipulated as a natural lane change area.

Optionally, in this embodiment of this application, the method further includes: determining a second velocity set of the target vehicle according to the first velocity set of the reference vehicle and a traffic status of a second segment, where the second velocity set includes velocity information in one-to-one correspondence to at least one time point, the second velocity set is used to provide reference for planning a velocity at which the target vehicle drives in the second segment when the target vehicle drives in the first segment, and the second segment is a next segment into which the target vehicle drives from the first segment; and sending the second velocity set to the target vehicle.

Specifically, after the first velocity set for the first segment is planned, planning the second velocity set for a forward segment may continue by using steps similar to the steps for planning the first velocity set for the first segment; or the second velocity set may be determined by using steps similar to the steps for planning the first velocity set for the first segment in combination with a traffic status of the forward segment. The forward segment is an immediately-following segment in a downstream direction of the first segment, that is, a next segment in a driving direction of the vehicle. This rolling planning approach can avoid a collision at a place at which a plurality of road sections connect. The control center may alternatively plan a plurality of segments in a forward direction. This is not limited in this embodiment of this application.

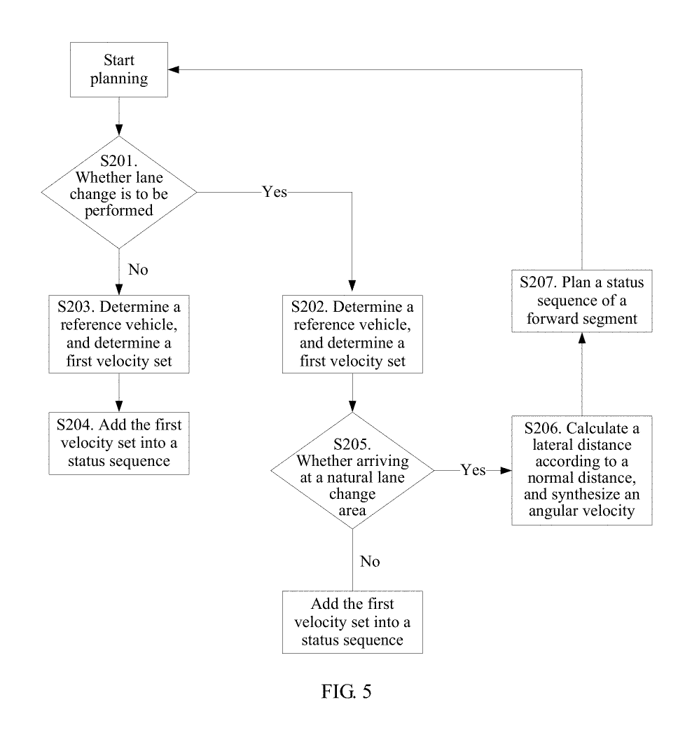

The following describes a specific process of a path planning method 200 in this embodiment of this application in detail with reference to FIG. 5. As shown in FIG. 5, assuming that a target vehicle drives in a lane 1 shown in FIG. 1, the method 200 mainly includes the following process:

S201. When the target vehicle drives in a segment 1 of the lane 1, the control center determines whether the vehicle needs to perform lane change; and when the target vehicle has a lane change requirement, proceeds with step S202, or when the vehicle does not have a lane change requirement, proceeds with step S203.

S202. Consider all preceding vehicles of the target vehicle in an entire road section to determine a reference vehicle from all vehicles that drive, within a period of time, into a next segment into which the target vehicle drives when performing lane change, and plan a first velocity set of the target vehicle according to a velocity set of the reference vehicle, where the period of time may be a period of time following a planning time point, for example, 10 s following the planning time point.

S203. Consider all preceding vehicles of the target vehicle in the entire road section to determine a reference vehicle from all vehicles that drive into a next segment of the first segment, and plan a first velocity set of the target vehicle according to a velocity set of the reference vehicle.

S204. Add the first velocity set determined in step S203 into a status sequence of the target vehicle.

S205. Determine whether the vehicle has driven into a natural lane change area; and if not, add the first velocity set planned in step S202 or an angular velocity determined in the following step S206 into a status sequence of the target vehicle, or if yes, perform step S206.

S206. Calculate a lateral distance according to a normal distance, and synthesize an angular velocity.

S207. After step 204 or step 206 is completed, determine whether planning of the segment is complete, and if the planning is complete, proceed to plan a status sequence of a forward segment, with planning steps similar to steps S201 to S206.

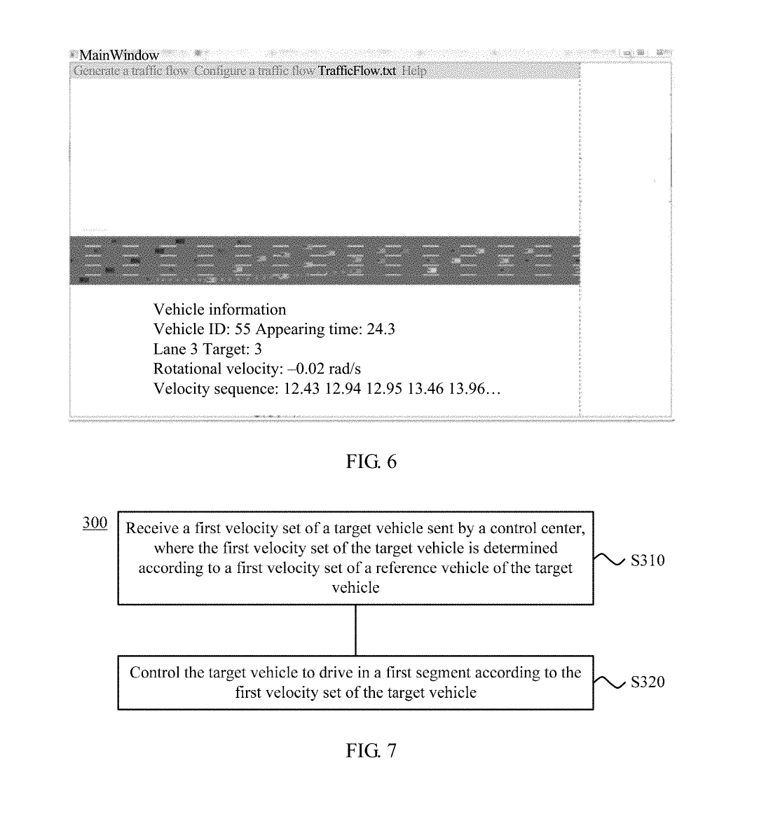

Simulation in this embodiment of this application is performed by using OpenAlpha based on a WPF framework of C# programming. Simulation software may describe a traffic model by setting a parameter file of a text document format, including static parameters such as a quantity of lanes, and a length, a width, and a direction of a lane (not necessarily driving from left to right), and dynamic parameters such as a velocity limit, an acceleration limit, an angular velocity limit, and a following distance to keep of a vehicle; or may describe a time point when a vehicle arrives at a start point, a start lane number, and a driving-out lane number by using a traffic flow file (there is a function, inside the program, for randomly generating a traffic flow, or a traffic flow file may be individualized outside the program by using a text editor). In addition, there are visual functions such as load display, vehicle information display, history track display, and collision detection, to facilitate detection of a road surface performance indicator. A simulation result may be shown in an example diagram of straight-going path planning in FIG. 6. An interface in FIG. 6 includes some vehicle information. For example, a vehicle identifier indicates a 55^{th} vehicle planned in the road section; the vehicle first appears in the road section at a time point 24.3 s, drives in from a lane 3, and is to drive out from the lane 3; an allocated rotational velocity is 0.02 rad/s; an allocated velocity sequence is 12.43, 12.94, 12.95, 13.46, 13.96, and so on.

It should be understood that this embodiment of this application is described by using only FIG. 6 as an example. For brevity, an example diagram of highway crossroad planning and an example diagram of traffic crossroad planning are not described one by one herein, and a method the same as the method of straight-going path planning is used for these two planning scenarios.

Therefore, according to the path planning method provided in this embodiment of this application, a possibility of implementing path planning for a large-scale road is greatly improved by applying car-following and rolling planning ideas. In addition, vehicle-road coordination is also implemented through processing of vehicle information in each segment and sharing of vehicle information in different segments. Therefore, the path planning method is of great potential for research on improvement of future traffic planning. Moreover, this embodiment of this application is also of significant meaning for improvement of overall traffic efficiency and accurate management of traveling time.

FIG. 7 is a schematic block diagram of a path planning method 300 according to an embodiment of this application. As shown in FIG. 7, the method 300 may be implemented by a vehicle-mounted terminal, and the method 300 includes the following steps:

S310. Receive a first velocity set of a target vehicle sent by a control center, where the first velocity set of the target vehicle is determined according to a first velocity set of a reference vehicle of the target vehicle.

S320. Control the target vehicle to drive in a first segment according to the first velocity set of the target vehicle

The first velocity set includes velocity information in one-to-one correspondence to at least one time point, the first segment is a next segment of a current driving segment of the target vehicle, the segment is a fixed length of road in a lane, and the reference vehicle is a preceding vehicle of the target vehicle.

Further, the first segment may be a segment in a lane, may be an intersection area of a road section and a ramp, or may be a traffic crossroad area. No limitation is set in this embodiment of this application.

In a possible implementation, the method further includes: receiving a second velocity set of the target vehicle sent by the control center, where the second velocity set includes velocity information in one-to-one correspondence to at least one time point, the second velocity set is used to provide reference for planning a velocity at which the target vehicle drives in a second segment when the target vehicle drives in the first segment, and the second segment is a next segment into which the target vehicle drives from the first segment.

In a possible implementation, the current driving segment and the first segment each are a fixed length of road in a different lane of a road section, the road section includes a plurality of parallel lanes, and the method further includes: receiving an angular velocity that is sent by the control center and that is required for the target vehicle to drive from the current driving segment into the first segment.

It should be understood that the interaction between the target vehicle and the control center and related features and functions described from a perspective of a vehicle side are corresponding to related features and functions on a control center side. For brevity, further details are not described herein.

It should also be understood that, in this embodiment of this application, the sequence numbers of the foregoing processes do not mean execution sequences. The execution sequences of the processes should be determined according to functions and internal logic of the processes, and should not be construed as any limitation on an implementation process of this embodiment of this application.

The path planning methods according to the embodiments of this application are described in detail with reference to FIG. 1 to FIG. 7, and the following provides embodiments of apparatuses of this application that may be configured to implement the method embodiments in this application. For undisclosed details in the apparatus embodiments of this application, refer to the method embodiments of this application.

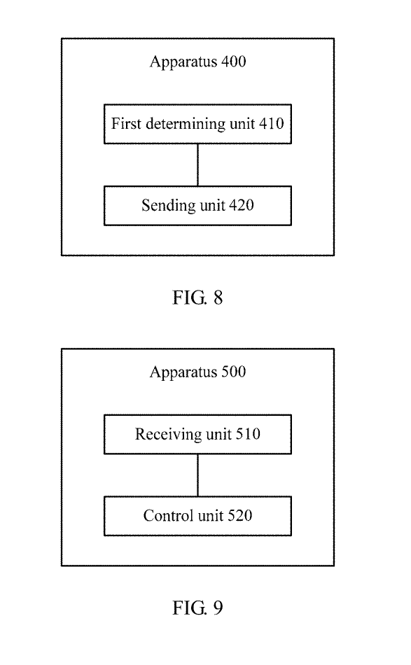

FIG. 8 is a schematic block diagram of a path planning apparatus 400 according to an embodiment of this application. As shown in FIG. 8, the apparatus 400 includes:

a first determining unit 410, configured to determine a first velocity set of a target vehicle according to a first velocity set of a reference vehicle of the target vehicle, where the first velocity set of the target vehicle is used to guide the target vehicle to drive in a first segment, and the first velocity set includes velocity information in one-to-one correspondence to at least one time point, the first segment is a next segment of a current driving segment of the target vehicle, the segment is a fixed length of road in a lane, and the reference vehicle is a preceding vehicle of the target vehicle; and

a sending unit 420, configured to send the first velocity set of the target vehicle to the target vehicle.

For example, the first segment is a fixed length of road in any lane of a first road section, the first road section includes a plurality of parallel lanes, and the apparatus 400 further includes a second determining unit 430, configured to determine a preceding vehicle nearest to the target vehicle as the reference vehicle, where the preceding vehicle includes at least one vehicle in each lane of the first road section that drives into the first segment earlier than the target vehicle.

For example, the first segment is a fixed length of road in any lane of a second road section, the second road section includes a plurality of parallel lanes, and the apparatus 400 further includes a third determining unit 440, configured to determine a preceding vehicle nearest to the target vehicle as the reference vehicle, where the preceding vehicle includes at least one vehicle in each lane of the second road section that drives ahead of the target vehicle.

For example, the first segment is any lane in an intersection area of a third road section and a ramp, the third road section includes a plurality of parallel lanes, the ramp includes a plurality of parallel lanes, and the apparatus 400 further includes a fourth determining unit 450, configured to determine a preceding vehicle nearest to the target vehicle as the reference vehicle, where the preceding vehicle includes at least one vehicle in each lane of the third road section and the ramp that drives into the first segment earlier than the target vehicle.

For example, the first segment is a first lane in a traffic crossroad, the traffic crossroad further includes a second lane, the first lane and the second lane have an intersection point, and the apparatus 400 further includes a fifth determining unit 460, configured to determine a preceding vehicle nearest to the intersection point as the reference vehicle, where the preceding vehicle includes at least one vehicle a distance from which to the intersection point is less than a distance from the target vehicle to the intersection point.

For example, the first determining unit 410 is further configured to determine a second velocity set of the target vehicle according to the first velocity set of the reference vehicle and a traffic status of a second segment, where the second velocity set includes velocity information in one-to-one correspondence to at least one time point, the second velocity set is used to provide reference for planning a velocity at which the target vehicle drives in a second segment when the target vehicle drives in the first segment, and the second segment is a next segment into which the target vehicle drives from the first segment; and the sending unit 420 is further configured to: send the second velocity set determined by the first determining unit to the target vehicle.

For example, the current driving segment and the first segment belong to different lanes of the road section, and the first determining unit 410 is further configured to determine, according to the first velocity set of the target vehicle and a normal distance of a radial center line of the first segment, an angular velocity required for the target vehicle to drive from the current driving segment into the first segment; and the sending unit 420 is further configured to send the angular velocity determined by the first determining unit to the target vehicle.

It should be understood that the path planning apparatus 400 according to this embodiment of this application may be corresponding to the control center in the path planning method 100 or the path planning method 200 in the embodiments of this application, and the foregoing and other operations and/or functions of the modules in the apparatus 400 are intended to implement corresponding processes of the method in FIG. 1 to FIG. 6. For brevity, details are not described herein again.

Therefore, according to the path planning apparatus provided in this embodiment of this application, a possibility of implementing path planning for a large-scale road is greatly improved by applying car-following and rolling planning ideas. In addition, vehicle-road coordination is also implemented through processing of vehicle information in each segment and sharing of vehicle information in different segments. Therefore, the path planning apparatus is of great potential for research on improvement of future traffic planning. Moreover, this embodiment of this application is also of significant meaning for improvement of overall traffic efficiency and accurate management of traveling time.

FIG. 9 is a schematic block diagram of a path planning apparatus 500 according to an embodiment of this application. As shown in FIG. 9, the apparatus 500 includes:

a receiving unit 510, configured to receive a first velocity set of a target vehicle sent by a control center, where the first velocity set of the target vehicle is determined according to a first velocity set of a reference vehicle of the target vehicle; and

a control unit 520, configured to control the target vehicle to drive in a first segment according to the first velocity set of the target vehicle; where

the first velocity set includes velocity information in one-to-one correspondence to at least one time point, the first segment is a next segment of a current driving segment of the target vehicle, the segment is a fixed length of road in a lane, and the reference vehicle is a preceding vehicle of the target vehicle.

In a possible implementation, the receiving unit 510 is further configured to receive a second velocity set of the target vehicle sent by the control center, where the second velocity set includes velocity information in one-to-one correspondence to at least one time point, the second velocity set is used to provide reference for planning a velocity at which the target vehicle drives in a second segment when the target vehicle drives in the first segment, and the second segment is a next segment into which the target vehicle drives from the first segment.

In a possible implementation, the current driving segment and the first segment each are a fixed length of road in a different lane of a road section, the road section includes a plurality of parallel lanes, and the receiving unit 510 is further configured to: receive an angular velocity that is sent by the control center and that is required for the target vehicle to drive from the current driving segment into the first segment.

It should be understood that the path planning apparatus 500 according to this embodiment of this application may be corresponding to the target vehicle in the path planning method 300 in the embodiments of this application, and the foregoing and other operations and/or functions of the modules in the apparatus 500 are intended to implement corresponding processes of the method in FIG. 7. For brevity, details are not described herein again.

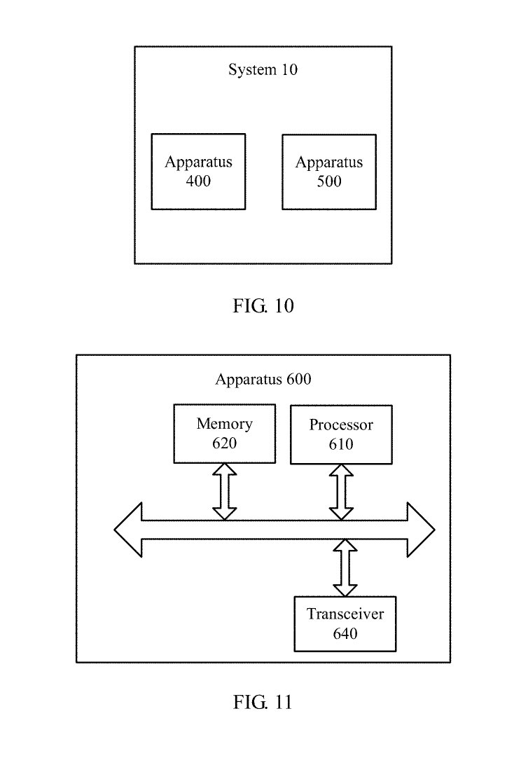

As shown in FIG. 10, an embodiment of this application further provides a system 10, including a control center and a vehicle. Specifically, the control center is corresponding to the control center in the method embodiments and the apparatus 400, and the vehicle is corresponding to the target vehicle in the method embodiments and the apparatus 500.

As shown in FIG. 11, an embodiment of this application further provides a path planning apparatus 600, and the apparatus 600 includes: a processor 610, a memory 620, and a transceiver 640. The processor 610, the memory 620, and the transceiver 640 communicate with each other by using an internal connection path. The memory 620 is configured to store an instruction. The processor 610 is configured to execute the instruction stored in the memory 620 to control the transceiver 640 to send a signal, and the processor 610 is configured to determine a first velocity set of a target vehicle according to a first velocity set of a reference vehicle of the target vehicle, where the first velocity set of the target vehicle is used to guide the target vehicle to drive in a first segment, and the first velocity set includes velocity information in one-to-one correspondence to at least one time point, the first segment is a next segment of a current driving segment of the target vehicle, the segment is a fixed length of road in a lane, and the reference vehicle is a preceding vehicle of the target vehicle; and send the first velocity set of the target vehicle to the target vehicle.

It should be understood that in this embodiment of this application, the processor 610 may be a Central Processing Unit (CPU), and the processor 610 may be another general purpose processor, a digital signal processor (DSP), an application-specific integrated circuit (ASIC), a field programmable gate array (FPGA) or another programmable logic device, a discrete gate or transistor logic device, a discrete hardware component, or the like. The general purpose processor may be a microprocessor, or the processor may be, for example, any conventional processor.

The memory 620 may include a read-only memory and a random access memory, and provides an instruction and data to the processor 610. A part of the memory 620 may further include a non-volatile random access memory. For example, the memory 620 may further store device-type information.

In an implementation process, the steps of the foregoing method may be implemented by using an integrated logic circuit of hardware in the processor 610 or by using an instruction in a form of software. The steps of the method disclosed with reference to the embodiments of this application may be implemented by directly using a hardware processor, or implemented by using a combination of hardware and a software module in the processor. The software module may be located in a storage medium mature in the art such as a random access memory, a flash memory, a read-only memory, a programmable read-only memory or an electrically erasable programmable memory, or a register. The storage medium is located in the memory 620. The processor 610 reads information in the memory 620 and implements the steps in the foregoing method in combination with the hardware of the processor. To avoid repetition, details are not described herein again.

Therefore, according to the path planning apparatus provided in this embodiment of this application, a possibility of implementing path planning for a large-scale road is greatly improved by applying car-following and rolling planning ideas. In addition, vehicle-road coordination is also implemented through processing of vehicle information in each segment and sharing of vehicle information in different segments. Therefore, the path planning method is of great potential for research on improvement of future traffic planning. Moreover, this embodiment of this application is also of significant meaning for improvement of overall traffic efficiency and accurate management of traveling time.

It should be understood that the path planning apparatus 600 according to this embodiment of this application may be corresponding to the control center and the apparatus 400 in the embodiments of this application, and may be corresponding to the control center configured to implement the method 100 or the method 200 according to the embodiments of this application, and the foregoing and other operations and/or functions of the units in the apparatus 600 are intended to implement corresponding processes of the method in FIG. 1 to FIG. 6. For brevity, details are not described herein again.

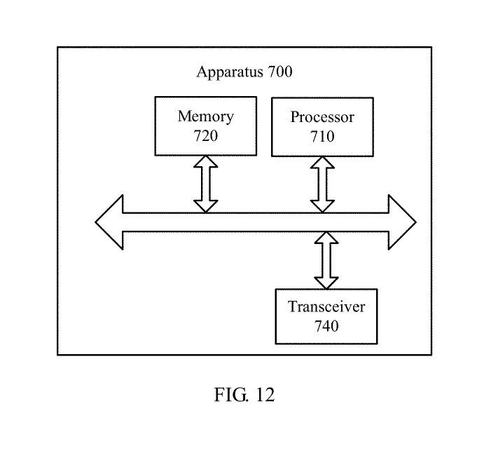

As shown in FIG. 12, an embodiment of this application further provides a path planning apparatus 700, and the apparatus 700 includes: a processor 710, a memory 720, and a transceiver 740. The processor 710, the memory 720, and the transceiver 740 communicate with each other by using an internal connection path. The memory 720 is configured to store an instruction. The processor 710 is configured to execute the instruction stored in the memory 720 to control the transceiver 740 to send a signal, and the processor 710 is configured to: receive a first velocity set of a target vehicle sent by a control center, where the first velocity set of the target vehicle is determined according to a first velocity set of a reference vehicle of the target vehicle; and control the target vehicle to drive in a first segment according to the first velocity set of the target vehicle; where the first velocity set includes velocity information in one-to-one correspondence to at least one time point, the first segment is a next segment of a current driving segment of the target vehicle, the segment is a fixed length of road in a lane, and the reference vehicle is a preceding vehicle of the target vehicle.

It should be understood that in this embodiment of this application, the processor 710 may be a central processing unit (Central Processing Unit, CPU for short), and the processor 710 may be another general purpose processor, a digital signal processor (DSP), an application-specific integrated circuit (ASIC), a field programmable gate array (FPGA) or another programmable logic device, a discrete gate or transistor logic device, a discrete hardware component, or the like. The general purpose processor may be a microprocessor, or the processor may be, for example, any conventional processor.

The memory 720 may include a read-only memory and a random access memory, and provides an instruction and data to the processor 710. A part of the memory 720 may further include a non-volatile random access memory. For example, the memory 720 may further store device-type information.

In an implementation process, the steps of the foregoing method may be implemented by using an integrated logic circuit of hardware in the processor 710 or by using an instruction in a form of software. The steps of the method disclosed with reference to the embodiments of this application may be implemented by directly using a hardware processor, or implemented by using a combination of hardware and a software module in the processor. The software module may be located in a storage medium mature in the art such as a random access memory, a flash memory, a read-only memory, a programmable read-only memory or an electrically erasable programmable memory, or a register. The storage medium is located in the memory 720. The processor 710 reads information in the memory 720 and implements the steps in the foregoing method in combination with the hardware of the processor. To avoid repetition, details are not described herein again.

It should be understood that the path planning apparatus 700 according to this embodiment of this application may be corresponding to the target vehicle and the apparatus 500 in the embodiments of this application, and may be corresponding to the target vehicle configured to implement the method 300 according to the embodiments of this application, and the foregoing and other operations and/or functions of the units in the apparatus 700 are intended to implement corresponding processes of the method in FIG. 7. For brevity, details are not described herein again.

It should be understood that in the embodiments of this application, “B corresponding to A” indicates that B is associated with A, and B may be determined according to A. However, it should also be understood that determining A according to B does not mean that B is determined according to A only. B may alternatively be determined according to A and/or other information.

A person of ordinary skill in the art may be aware that the units and algorithm steps in the examples described with reference to the embodiments disclosed in this specification may be implemented by using electronic hardware, computer software, or a combination thereof. To clearly describe the interchangeability between hardware and software, the foregoing has described in general compositions and steps of each example based on functions. Whether the functions are performed by hardware or software depends on particular applications and design constraint conditions of the technical solutions. A person skilled in the art may use a different method for each particular application to implement the described functions, but it should not be considered that the implementation goes beyond the scope of this application.

It may be clearly understood by a person skilled in the art that, for the purpose of convenient and brief description, for a detailed working process of the foregoing system, apparatus, or unit, reference may be made to a corresponding process in the foregoing method embodiments, and details are not described herein again.

In the several embodiments provided in this application, it should be understood that the disclosed system, apparatus, and method may be implemented in other manners. For example, the described apparatus embodiments are merely examples. For example, the unit division is merely logical function division and may be other division in actual implementation. For example, a plurality of units or components may be combined or integrated into another system. In addition, functional units in the embodiments of this application may be integrated into one processing unit, or each of the units may exist alone physically, or two or more units may be integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of this application essentially, or the part contributing to the prior art, or all or a part of the technical solutions may be implemented in the form of a software product. The software product is stored in a storage medium and includes several instructions for instructing a computer device (which may be a personal computer, a server, or a network device, or the like) to perform all or a part of the steps of the methods described in the embodiments of this application. The foregoing storage medium includes: any medium that can store program code, such as a USB flash drive, a removable hard disk, a read-only memory (Read-Only Memory, ROM), a random access memory (Random Access Memory, RAM), a magnetic disk, or an optical disc.

The foregoing descriptions are merely specific implementations of this application, and the protection scope of this application is not limited thereto. Any person skilled in the art can readily figure out various equivalent variations or replacements within the technical scope disclosed in this application.

What is claimed is:

1. A path planning method, comprising:
determining a first velocity set of a target vehicle according to a first velocity set of a reference vehicle of the target vehicle, wherein the first velocity set of the target vehicle is used to guide the target vehicle to drive in a first segment of a lane of a road section, and the first velocity set of the target vehicle comprises velocity information in one-to-one correspondence to at least one time point, the first segment is a next segment of a current driving segment of the target vehicle, and the reference vehicle is a preceding vehicle of the target vehicle; and
sending the first velocity set of the target vehicle to the target vehicle.

2. The method according to claim 1, wherein the first segment is a fixed length of road in a lane of a road section, the first road section comprises a plurality of parallel lanes, and the method further comprises:
determining a preceding vehicle nearest to the target vehicle as the reference vehicle, wherein the preceding vehicle is determined from preceding vehicles that comprise at least one vehicle in each lane of the road section that drives into the first segment earlier than the target vehicle.

3. The method according to claim 1, wherein the first segment is a fixed length of road in a lane of a road section, the road section comprises a plurality of parallel lanes, and the method further comprises:
determining a preceding vehicle nearest to the target vehicle as the reference vehicle, wherein the preceding vehicle is determined from preceding vehicles that comprise at least one vehicle in each lane of the road section that drives ahead of the target vehicle.

4. The method according to claim 1, wherein the first segment is a lane in an intersection area of a road section and a ramp, the road section comprises a plurality of parallel lanes, the ramp comprises a plurality of parallel lanes, and the method further comprises:
determining a preceding vehicle nearest to the target vehicle as the reference vehicle, wherein the preceding vehicle is determined from preceding vehicles that comprise at least one vehicle in each lane of the road section and the ramp that drives into the first segment earlier than the target vehicle.

5. The method according to claim 1, wherein the first segment is a first lane in a crossroad, the crossroad further comprises a second lane, the first lane and the second lane have an intersection point, and determining a preceding vehicle nearest to the intersection point as the reference vehicle, wherein the preceding vehicle is determined from preceding vehicles that comprise at least one vehicle a distance from which to the intersection point is less than a distance from the target vehicle to the intersection point.

6. The method according to claim 1, wherein the method further comprises:
determining a second velocity set of the target vehicle according to the first velocity set of the reference vehicle and a traffic status of a second segment of a lane of the road section, wherein the second velocity set of the target vehicle comprises velocity information in one-to-one correspondence to at least one time point, the second velocity set is used to provide reference for planning a velocity at which the target vehicle drives in the second segment when the target vehicle drives in the first segment, and the second segment is a next segment into which the target vehicle drives from the first segment; and
sending the second velocity set to the target vehicle.

7. The method according to claim 1, wherein the current driving segment and the first segment belong to different lanes of the road section, and after the determining a first velocity set of a target vehicle according to a first velocity set of a reference vehicle of the target vehicle, the method further comprises:
determining, according to the first velocity set of the target vehicle and a normal distance of a radial center line of the first segment, an angular velocity for the target vehicle to drive from the current driving segment into the first segment; and
sending the angular velocity to the target vehicle.

8. A path planning apparatus, wherein the apparatus comprises:
a transmitter;
at least one processor;
a non-transitory computer-readable storage medium coupled to the at least one processor and storing programming instructions for execution by the at least one processor, the programming instructions instruct the at least one processor to:
determine a first velocity set of a target vehicle according to a first velocity set of a reference vehicle of the target vehicle, wherein the first velocity set of the target vehicle is used to guide the target vehicle to drive in a first segment of a lane of a road section, and the first velocity set of the target vehicle comprises velocity information in one-to-one correspondence to at least one time point, the first segment is a next segment of a current driving segment of the target vehicle, and the reference vehicle is a preceding vehicle of the target vehicle; and
send, using the transmitter, the first velocity set of the target vehicle to the target vehicle.

9. The apparatus according to claim 8, wherein the first segment is a fixed length of road in a lane of a road section, the first road section comprises a plurality of parallel lanes, and the programming instructions further instruct the at least one processor to:
determine a preceding vehicle nearest to the target vehicle as the reference vehicle, wherein the preceding vehicle is determined from preceding vehicles that comprise at least one vehicle in each lane of the road section that drives into the first segment earlier than the target vehicle.

10. The apparatus according to claim 8, wherein the first segment is a fixed length of road in any lane of a road section, the road section comprises a plurality of parallel lanes, and the programming instructions further instruct the at least one processor to:
determine a preceding vehicle nearest to the target vehicle as the reference vehicle, wherein the preceding vehicle is determined from preceding vehicles that comprise at least one vehicle in each lane of the second road section that drives ahead of the target vehicle.

11. The apparatus according to claim 8, wherein the first segment is a lane in an intersection area of a road section and a ramp, third road section comprises a plurality of parallel lanes, the ramp comprises a plurality of parallel lanes, and the programming instructions further instruct the at least one processor to:
determine a preceding vehicle nearest to the target vehicle as the reference vehicle, wherein the preceding vehicle is determined from preceding vehicles that comprises at least one vehicle in each lane of the third road section and the ramp that drives into the first segment earlier than the target vehicle.

12. The apparatus according to claim 8, wherein the first segment is a first lane in a crossroad, the crossroad further comprises a second lane, the first lane and the second lane have an intersection point, and the programming instructions further instruct the at least one processor to:
determine a preceding vehicle nearest to the intersection point as the reference vehicle, wherein the preceding vehicle is determined from preceding vehicles that comprise at least one vehicle a distance from which to the intersection point is less than a distance from the target vehicle to the intersection point.

13. The apparatus according to claim 8, wherein the programming instructions further instruct the at least one processor to:
determine a second velocity set of the target vehicle according to the first velocity set of the reference vehicle and a traffic status of a second segment of a lane of the road section, wherein the second velocity set of the target vehicle comprises velocity information in one-to-one correspondence to at least one time point, the second velocity set is used to provide reference for planning a velocity at which the target vehicle drives in the second segment when the target vehicle drives in the first segment, and the second segment is a next segment into which the target vehicle drives from the first segment; and
send, using the transmitter, the second velocity set to the target vehicle.

14. The apparatus according to claim 8, wherein the current driving segment and the first segment belong to different lanes of the road section, and the programming instructions further instruct the at least one processor to:
determine, according to the first velocity set of the target vehicle and a normal distance of a radial center line of the first segment, an angular velocity for the target vehicle to drive from the current driving segment into the first segment; and
send, using the transmitter the angular velocity determined by the first determining unit to the target vehicle.
